(19) United States
(12) Patent Application Publication
(10) Pub. No.: US 2008/0141363 A1
(43) Pub. Date: Jun. 12, 2008

(54) Pattern Based Password Method and System Resistant to Attack by Observation or Interception

(76) Inventor: John Sidney White, Johannesburg (ZA)

Correspondence Address: BROOKS KUSHMAN P.C., 1000 TOWN CENTER, TWENTY-SECOND FLOOR, SOUTHFIELD, MI, 48075, US

(21) Appl. No.: 11/814,629

(22) PCT Filed: Jan. 27, 2006
(86) PCT No.: PCT/ZA06/00013

§ 371 Date: Jul. 24, 2007

(30) Foreign Application Priority Data
Jan. 27, 2005 (ZA) 2005/0802
Mar. 17, 2005 (ZA) 2005/02237
Aug. 11, 2005 (ZA) 2005/06391

(51) Int. Cl. G06F 7/10

(52) U.S. Cl. 726/18

(57) ABSTRACT

A password method and system is described in which the legitimate user persuades the validating element of the system of his identity by identifying specific data in sequence from within a collection of data by means of associated reference data. No password information need be transmitted over networks and encryption is not required. Thus the user establishes his identity without disclosing his underlying password to an observing or data intercepting third party. The concept of requiring a user to identify password data hidden within extraneous data is not new, but practical issues relating to ease of use and ease of password deduction have limited the use of these systems, which have therefore remained essentially of academic interest. This invention identifies and addresses weaknesses of this technology and defines a system capable of immediate commercial use in for example; ATMs, Corporate networks, Internet Banking and Electronic Locking systems etc.

### TECHNICAL FIELD

The invention relates to a method for verifying the identity of a user accessing one or more secure applications or systems, such as a computer, on-line service, automated transaction mechanism including ATMs, electronic locking mechanism, etc., in which the human capacity for private thought is central to user verification.

### BACKGROUND ART

In general terms, most forms of access control to secure systems (computer and other) rely on a combination of 2 elements namely; “What the legitimate user possesses” and “What the legitimate user knows”. Identity cards, so-called “smart cards” with computer memory chips, encrypted security tokens, one-time electronic password generators are examples of security devices that may be possessed. Biometric data relating to the user may also be regarded as a possession of the legitimate user in some contexts. Password systems in one shape or another represent the “What the user knows” element of the majority of secure systems. One of the most common password forms is the personal identity number (PIN) used widely to identify users to automated teller machines (ATMs). Such PINs are normally 4 or 5 digit numbers that must be entered in sequence to be checked against a stored record. Passwords are also commonly used to verify identity remotely such as when connecting to an on-line service for Internet banking or shopping.

Except where some physical attribute of the user attempting to gain access to a secure system such as Retinal image or Fingerprint may be directly verified against stored data in a secure and tamper proof manner, the common problem is how to verify that an aspirant user is in fact who he or she claims to be. The vast majority of applications do not facilitate direct measurement of physical attributes and almost all “what the user possesses” devices do not know in fact who possesses them. Biometrics only differ from other “what the user possesses” devices when they may be directly verified in a controlled environment because data relating to biometric information transmitted over computer networks it is as open to copying, analysis and re-use as any other data. Existing PIN usage and usage of more complex passwords such as those that may be used for Internet banking etc. may be compromised by a third party either by directly observing the entered data or by interception of transmitted data. Another danger is the possibility of “man in the middle” interception where a third party manages to “hi-jack” or break into, a legitimate user session thereby appearing to the serving application to be the legitimate user, obviating to need to defeat the password system.

The challenge then is to strengthen the “What the user knows” element of identity verification in a way that provides additional security against anticipated forms of attack and to do so in a way that is simple and practical given that many people have difficulty simply remembering their 4 digit PIN.

Various approaches to hiding or disguising password entry have been put forward to strengthen the “What the user knows” security element.

Hoover U.S. Pat. No. 6,209,102 is directed at hiding the entered password by requiring the user to manipulate selectable fields from an initial randomised state to a final state representing the correct access code. This approach merely introduces a degree of difficulty to the attacker and depends for its security on weaknesses within the observation method used by the attacker. If fully observed, this method will readily be compromised because where the initial and final state of the manipulated data are known, it will be possible to derive the underlying logic. This approach is also too complex to be commercially acceptable.

Patarin, et al.-U.S. Pat. No. 5,815,083 is also directed at hiding the entered password by using various means to hinder the continuity of the visual link between keys struck on a keyboard and the prompting data displayed on a screen. This approach again merely introduces a degree of difficulty to the attacker and depends for its security on weaknesses within the observation method used by the attacker. It introduces slight difficulty to the attacker at the expense of presenting the user with almost the same degree of difficulty.

Davies U.S. Pat. No. 5,608,387 proposes a system whereby subtly differing complex facial expressions or appearances in a matrix displayed on a screen are recognised visually by an authorised user to select a visually recognised facial image, which represents the password. Davies addresses the over-the-shoulder problem by relying on the human ability to distinguish complex, subtle differences in facial expressions.

Cottrell U.S. Pat. No. 5,465,084 describes a system whereby a user is presented with a blank grid and selects a pattern of letters on a screen. This pattern is compared with a stored master pattern to determine whether a proper match of the pattern has been entered. Cottrell relies on the large number of combinations possible by making positioning of password characters in more than one dimension and the colour of the data elements possible components of the password. Cottrell requires that password characters be entered in a grid pattern. This approach is also too complex for general use and is susceptible to attack by analysing successive successful logons using reverse pattern matching.

Baker U.S. Pat. No. 5,428,349 is directed to a password entry system in which the password is embedded in various columns and rows, which are then selected to indicate the password. In a representative embodiment of that invention, a user picks a six-character column out of six such columns displayed on a screen that contains the proper character of a password. This is done for each character of the password. In this way, Baker provides deterrence against third party observation of the password and provides transmission protection. Again, this approach is too complex for general use and is susceptible to attack by analysing successive successful logons.

Park Seung-bae-PCT application PCT/KR2003/001617 is directed to a password entry system using two or more groups of cells which are matched using matching rules to generate a derived password not immediately obvious from the unmatched cell groups. This approach deals with the over-the-shoulder problem and the interception problem for a single logon transaction but is readily susceptible to derivation of the matching rules by repeated observation using pattern analysis except where the complexity of the required user activity is elevated to a level that is completely impractical for general use. Also, in practice it is possible that many users would share similar or equal matching rules in which case a third party that understands the system would readily be able to analyse the input of another. This approach is again far too complex for general use.

### SUMMARY OF INVENTION

The essence of the disclosed password method and system is that there is no password in the conventional sense to be delivered to a verifying system element. Instead, the end user employs one or more memory aids to identify specific data from within a body of data that contains sufficient extraneous data so as to confuse persons attempting unauthorized access. The verifying element within the secure system is initially made aware of the memory aids associated with a user and knows the rules governing the use of those memory aids, it is also aware of the full extent of data presented to the user for each identity verification transaction. Armed with this knowledge, the verifying element is able to confirm whether or not the data entered by the user is consistent with the application of that specific user's memory aids. Memory aids may take many forms and might be conventional word based or alpha numeric or numeric “passwords” together with simple password usage rules. Alternatively, memory aids might take the form of geometric patterns or specific knowledge of a picture or image. Memory aids will hereinafter also be referred to as “passwords” or “underlying passwords”. A feature of this password system is that a given memory aid may be applied in a variety of ways to the body of data thereby further confusing persons observing the logon. The identified data (which may also be modified further) is hereinafter referred to as the “derived password” or “derived logon password” and is entered by the end user to be sent to the verifying system element such as an Institutional Server.

The concept of an “Offset Key” is a feature of this invention and is defined here as one or more rules or options used to modify the data identified within the body of data. The level of security achieved with this password system will always involve a “Trade-off” between the complexity and volume of data displayed, the ease of identifying the specific password data and the susceptibility of the system to “cracking” by the use of pattern analysis to derive the underlying password. The offset key enables the security of the system to be increased without increasing the amount of data displayed. Because of the volume of extraneous data present and/or taking into account the effect of the “offset key” the actual data entered by the end user to effect the logon on each occasion could potentially be derived from the displayed data in many ways (scalable up to very large numbers). Hence the underlying password or memory aid is difficult to derive by observation.

The protection offered by this system is substantial as no information directly associated with the underlying password or passwords is ever present outside of the secured end of the network connection or other validating facility. A novel aspect of this invention compared with conventional password systems including other proposed pattern based methods and systems is that even if an unauthorised person were to observe the end user's every key stroke or mouse movement and/or be connected to the end user's computer to capture every aspect of all data being processed to and from the secure verification system element during the logon process, such an unauthorised person would need to observe many transactions before obtaining sufficient information to be able to derive the user's underlying password.

The invention makes use of two data types that are displayed on the end user interface, which may be an ATM terminal, a business or personal computer, point of sale device, electronic lock interface or other form of data display and data entry device.
One data type is that which comprises the numbers or letters (or both) or symbols or images from which a derived password is obtained. These data vary with every logon transaction and are hereinafter referred to as the “Variable Data”. In some forms of the invention mathematical or other symbols may be contained within the variable data to be used as operators or instructions to the end user regarding the manipulation of the located data.
The other data type is not limited to numbers or letters or symbols or images and exists to enable the end user to locate specific data used to obtain the derived logon password within the Variable Data and in some forms of the invention it is also used to locate hidden instructions regarding the manipulation of the located data. This second data type is hereinafter referred to as the “Reference Data”.

There are an infinite variety of combinations of Variable and Reference data and it is this fact that enables the invention to be applied to a wide range of security applications with scalable security to suit the needs of those applications.

Pattern based password methods and systems using reference and variable data types to derive session specific passwords share a common weakness due to the fact that the reference data must in some way be associated with the variable data to be selected for use in obtaining the derived password for a particular logon transaction in a manner that is negotiable by a human user. Such methods may easily yield a derived password that for practical purposes cannot be deduced or guessed for the first observed and/or intercepted logon transaction. The problem is that such systems are susceptible to reverse pattern analysis in which the attacker overlays successive observed reference data and variable data arrays to detect repeating associations between displayed reference and variable data. This issue is addressed in the disclosed invention.

It should be noted that there is a difference in the odds of guessing the underlying password (memory aid) remembered by the user versus the odds of guessing the pattern. As the instances of each distinct character within the variable data array reduces so there is a reduction in the difficulty of guessing the underlying password by pattern analysis. A balance of 3 distinct security issues determines the security of this system:
1. The ability to determine the underlying password by pattern analysis of user input.
2. The ability to guess or determine the required user input directly, ignoring the underlying password completely.
3. The number of logons that pass before a given “derived password” (user input) is repeated.

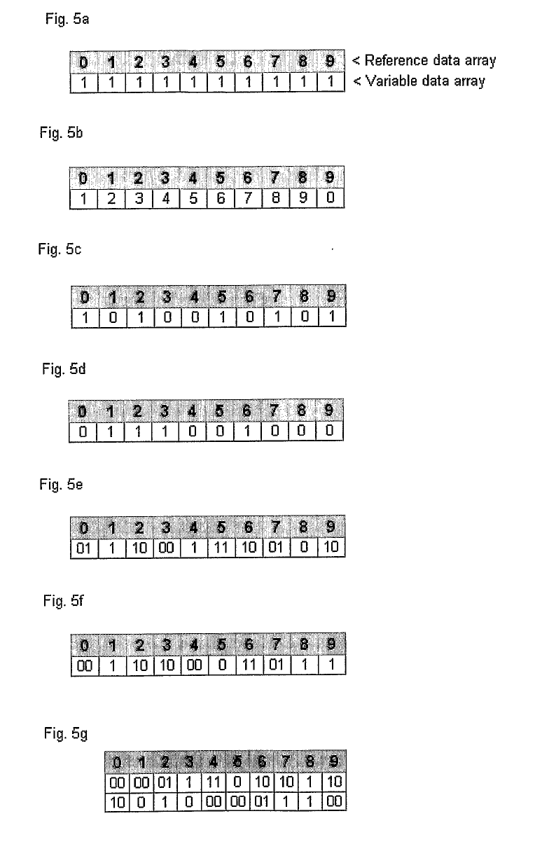

FIGS. 5a through 5e illustrate some of the fundamentals associated with the disclosed password system in terms of the three security issues mentioned above. Consider a memory aid or underlying password “2447” which might be an ATM PIN number to be entered using a method of the current invention:

FIG. 5a-Shows a two row grid in which the upper row contains the reference data and the second row contains the variable data. The user would locate variable data using the memory aid (2447) in the reference data yielding a derived password “1111”. In this example an attacker would not be able to derive the underlying password since the character “1” is associated with every datum in the reference row. However, the attacker would not need to deduce the underlying password, because for a given password length there is only one possible derived password to be entered. If the password length is known then the derived password may be immediately deduced whereas if the password length in not initially known then it will be revealed after a single observation of a successful logon or by trial and error.

FIG. 5b-Shows the same 2 row reference and variable data array in which the lower variable data now contains a different character in each cell. Considering the same memory aid “2447” the associated variable data yields the derived password “3558”. In this example, the odds of guessing either the memory aid or the derived password prior to observing a successful logon depend only on the length of the memory aid. In the case of a 4 digit memory aid, the odds of guessing either is 10 to the power 4 or 1 in 10,000. However, since each character in the variable data array occurs only once, the memory aid may be deduced after a single observation of a successful logon.

FIG. 5c-Shows how security may be increased by introducing 2 different characters into the cells of the variable data array. In this example, “2447” yields a derived password of “1001”. If the password length is 4 characters then prior to observing a successful logon the odds guessing the memory aid remains 1 in 10,000 whereas the odds of guessing the derived password will be 2 to the power of 4 (1 in 16). However, the situation changes after a single observation of a successful logon. The first character of the underlying password can only be 0,2,5,7 or 9; the second character can only be 1,3,4,6 or 8 and so on for the 3^{rd} and 4^{th} characters. The variable data array must be changed for the next logon transaction in order to invalidate the previous derived password. FIG. 5d shows a possible next variable data array yielding a derived password “1000”1 . Pattern analysis can now begin to reveal the underlying password: The first character is one of 1,2,3 or 6 and since only 2 is common to the first and second observed logons the first character is revealed as “2”. The second character is one of 0,4,5,7,8 or 9 and since both 4 and 8 are common to first and second logons the second character of the underlying password is revealed as either 4 or 8. From this, it is clear that the underlying password will be discovered very quickly.

FIG. 5e-Shows how security may be further increased by employing combinations of 1 or 2 characters in each cell of the variable data array. The derived password is now “101101” and the first character may be any of 1,2,4,6 or 9 and the second character any of 0,1,4,5,7 or 8. FIG. 5f shows a possible second variable data array yielding a derived password of “10000001” where the first character is one of 1,2,3,8 or 9 and the second character is one of 0,4 or 5. From this it is clear that the memory aid or underlying password will be derived after only a slightly higher number of successful logons. The use of an algorithm to ensure the largest number of possible reference cells per derived password character can extend the security offered in this example. In practice, this level of protection would be suitable for use in the context of ATMs where so-called “over the shoulder” observation relies on identifying the user's password in one go. If the number of required observations which must be fully recorded and analysed is increased to say 8 or 9 it would take a very persistent attacker to obtain the legitimate user's password.

In the examples show under FIG. 5e and 5f, security may be further increased by allowing the user to arbitrarily drop the first or last character of the derived password in terms of “offset key” rules, thereby further hindering the pattern analysis of the entered “password” which is now less than the full initially derived password.

FIG. 5g shows how security may be increased by increasing the number of variable data rows from which the derived password may be obtained.

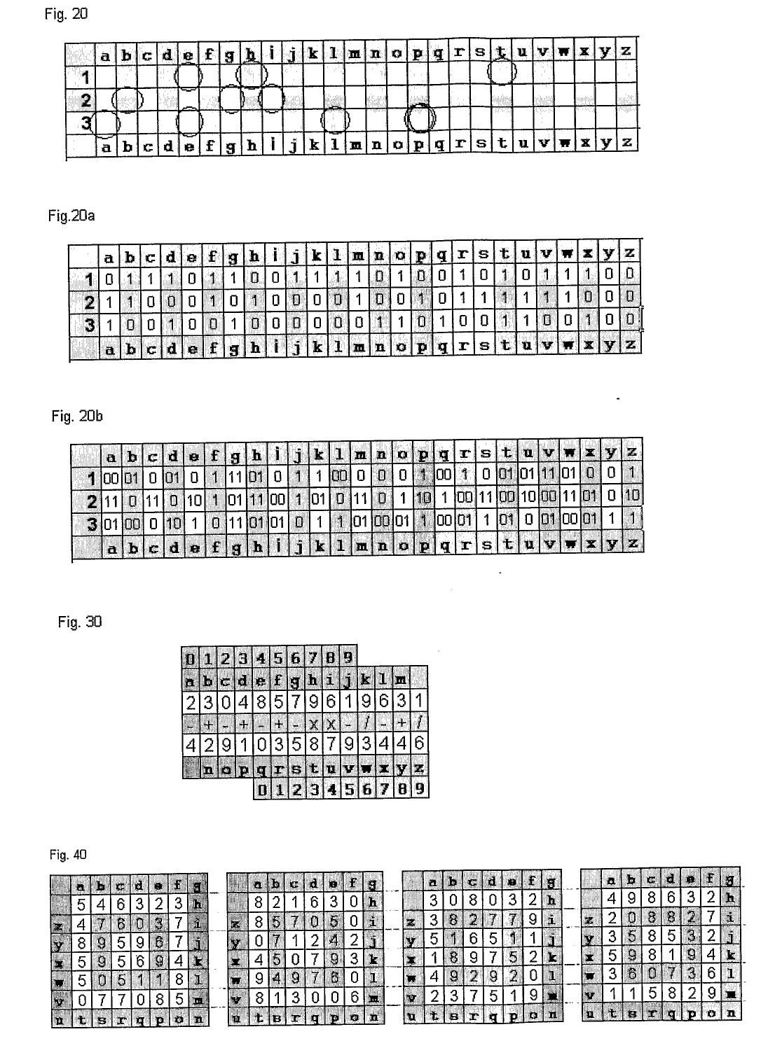

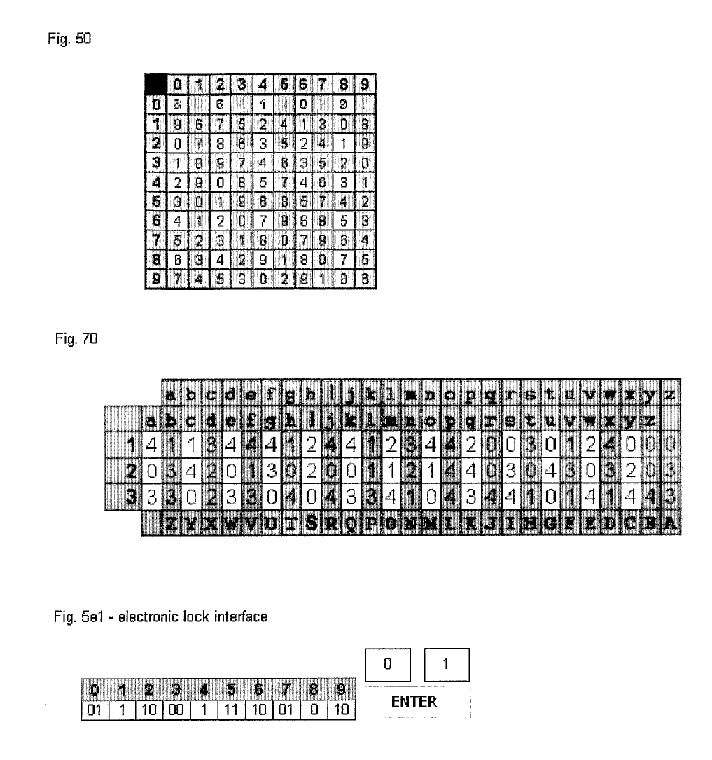

FIG. 20 Shows a combination row and column reference array with blank variable data array elements. The circled cells point to a memory aid “the big apple” (spaces omitted) reading from top to bottom one word per row. FIGS. 20a and 20b indicate how the variable data array might be populated in low (FIG. 20a) or high (FIG. 20b) security mode. In this example of the invention where free form phrases may be used as memory aids, very long passwords may easily be employed. Considering FIG. 20b and memory aid “the big apple”, the derived password is “0101000001011111”. Sixteen characters means 2 to the power 16 chances of guessing the derived password (per logon attempt) without reference to the memory aid, which is 1 in 65536. The difficulty facing the attacker is further compounded by the fact that over such a long password, the number of characters found in the derived password may vary considerably over a number of observed logons. The use of offset key rules such as arbitrarily dropping the first character at the user's discretion greatly hinders pattern analysis for this relatively large variable data array. Pattern analysis may be hindered further by allowing the user to enter any word of the memory aid in any row. Such measures will reduce the difficulty of simply guessing the required derived password from scratch but in this example if the user has 6 ways to enter “the big apple” the difficulty of pattern analysis is massively increased at the cost of allowing just 6 in 65536 (1 in over 10,000) opportunities to guess the derived password independently.

The current invention is scalable to suit the needs of the interface that is to be protected. A preferred embodiment of the invention in terms of a method and system relating to an Automated Teller Machine (ATM) could make use of a grid as depicted in FIG. 5e.

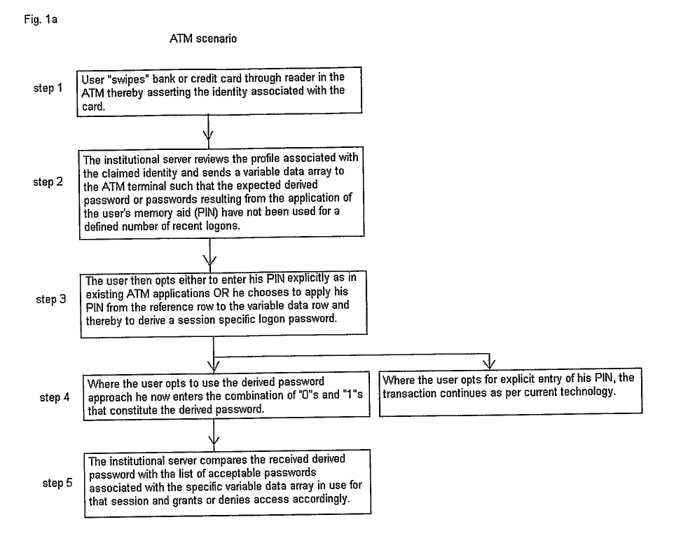

FIG. 1a shows how the technology may easily be applied.

Step 2 in FIG. 1a indicates the preferred method of populating the variable data array displayed to the user from the institutional server. However, in some circumstances it may be desirable to allow the complete display to be generated at the user interface device. In such cases the complete variable data array must be transmitted to the institutional server so that the array may be checked for compliance with security rules appropriate to the nature of the array. For example the server must check that the remotely generated variable data array contains adequately diverse and distributed data such that the derived password remains hidden except to the legitimate user. This is necessary to prevent an attacker from introducing an array containing a single character in order to force a known derived password.

Step 3 in FIG. 1a indicates that the user may be given the choice of password entry (existing method or new reference/derived password method). This is an important commercial aspect of the invention: Because the invention may employ existing passwords (PINs etc.), it will be relatively easy to introduce the new method with minimum disruption to the end users as they could be allowed to continue entering their PINs explicitly until they are comfortable with the new system.

In Step 4 the data entered by the user is transmitted over a network to the institutional server and it is important to note that this may be done “in the clear”. In other words, there is no need to encrypt the user's response.

A second preferred embodiment of the invention would use a grid such as that shown in FIG. 20b to deliver a very high level of security. With such a grid, the ability to use memory aids ranging from single words like “apple” to those comprising long, easy to remember phrases such as “the big apple” or “the tree at the bottom of my garden”, and the facility to use the memory aid in a number of ways means that the security against all forms of attack may be raised to the point where successful attack is practically impossible. Additionally, in the context of on-line banking or shopping the preferred embodiment of a high security application would use transaction confirmations whereby the institutional server would ask for a new derived password against a new variable data array for each major transaction. In this way, an attacker who managed to place himself between the legitimate user and the server after the legitimate user logged on to a service, would not be able to transact with the server because he would have no way of correctly responding to the transaction confirmation requests. The legitimate user on the other hand would simply become more and more adept at entering his same underlying password. The legitimate user would most likely find the obvious security of his dealings with the institution most satisfying to the point where the secure institution would enjoy a distinct marketing advantage over its less secure competitors.

In recent years, the concept and reality of identity theft has become established to the extent that banks and other commercial institutions accept that fraud may be committed when customers' access codes are compromised. In the absence of a simple and effective “what the user knows” security element, institutions throw more and more costly technology against the mounting threat of high tech crime. The simple fact is that technological security will always be at risk from technological attack. The cost to business of this condition is very high and will only increase in years to come.

Using the current invention, it is possible to place responsibility for the security of the customer's access codes back into the hands of the customer. By strengthening the “what the user knows” security element to the point where for the high end applications an attacker could only succeed if he was given the memory aid by the legitimate user, users can be held responsible for activities on their accounts.

The nature of the security offered by this invention is such that a finite and predictable number of fully recorded logons are required to obtain sufficient information to defeat the system. The application of algorithms or so-called “dictionary” methods etc., employed to attack the system have no foundation on which to derive a solution to the user's secret knowledge by logic.

This invention provides a simple and practical security solution that is as simple and effective as merely keeping your thoughts private.

1.-15. (canceled)

16. A method of verifying the identity of a user of a computer system which includes the steps of:
a) providing the user with one or more secret ID codes comprising a number of user characters;
b) providing the user with one or more usage rules governing how the secret ID codes may be used to locate matrix characters within a matrix to be supplied;
c) generating the matrix for an identity verification session comprising an array of cells in which each cell contains one or more matrix characters and in which each cell may be referenced by column and/or row labels in which the user characters may be found together with other superfluous characters;
d) the matrix being created in a single process from a single source and the matrix being made available to the user and the computer system;
e) entering into the user interface of the computer system a user sequence of characters based on matrix characters selected by the user employing one of the secret ID codes and the usage rules;
f) generating within the computer system one or more comparison sequences of matrix characters derived from the application of each of the user's secret ID codes using the matrix and the usage rules; and
g) checking the user sequence against one or more comparison sequences and verifying the identity of the user upon finding a match.

17. A method according to claim 16 in which the usage rules provide the user with methods to be used at the user's discretion such that in successive identity verification sessions the relationship between the secret ID code and the user sequence of characters is varied.

18. A method according to claim 16 in which the usage rules include one or more methods for the modification of the located matrix characters.

19. A method according to claim 16 in which the usage rules include using the secret ID code as a whole or broken down into parts where such parts might be words or other groupings known to the user.

20. A method according to claim 16 in which the relationship between the user sequence and the user's secret ID codes is hidden by one or more of the following steps with the secret ID code or part or parts thereof:
a) omit or repeat the first one or two characters of the sequence of matrix characters selected by the user;
b) omit or repeat the last one or two characters of the sequence of matrix characters selected by the user;
c) where the matrix comprises multiple array rows, the user sequence may be obtained from any one row;
d) where the matrix comprises multiple array rows, the user sequence must be obtained from one specific row;
e) where the matrix comprises multiple array rows, the user sequence may be obtained from a variety of row combinations per secret ID code part;
f) the sequence of matrix characters selected by the user may be read in columns offset by a specified number of columns from that identified by the user' s secret ID code;
g) arithmetic operations may be known secretly to the user to be used to modify one or more of the matrix characters selected by the user; and
h) arithmetic operators may be contained in the matrix to be used in accordance with usage rules to modify one or more of the matrix characters selected by the user.

21. A method according to claim 16 in which only two distinct matrix characters are used within the entire user selectable area of the matrix with one or more of these distinct matrix characters contained per matrix cell.

22. A method according to claim 16 in which multiple characters contained per matrix cell are aligned horizontally side by side or vertically one above the other or otherwise positioned relative to each other such that the user may readily reference first or last or middle characters contained per cell.

23. A method according to claim 16 in which the number of user selectable matrix rows is equal to or greater than the number of permutations of matrix characters per matrix cell and where each matrix column contains at least one of each such permutations.

24. A method according to claim 16 in which the number of user selectable matrix columns is equal to or greater than the number of permutations of matrix characters per matrix cell and where each matrix row contains at least one of each such permutations.

25. A method according to claim 16 in which the matrix supplied to the user is generated within the computer system according to the following steps:
a) the matrix cells are populated according to an algorithm, then
b) all permutations of sequences of matrix characters that may be selected by the user are checked to ensure an acceptable variety of matrix characters is present and that the numbers of contiguous matrix characters is within defined limits, if these checks are not satisfactory return to step 25a), otherwise
c) all permutations of sequences of matrix characters that may be selected by the user are compared with a stored history of successful user verifications, then
d) if a recently used sequence of matrix characters is matched with a possible sequence of matrix characters from the current session, return to step 25a).

26. A method according to claim 16 in which the matrix supplied to the user is generated within the computer system according to the following steps:
a) only the matrix cells that may be selected by the user by reference to the secret ID codes are initially populated according to an algorithm, then
b) all permutations of sequences of matrix characters that may be selected by the user are checked to ensure an acceptable variety of matrix characters is present and that the numbers of contiguous matrix characters is within defined limits, if these checks are not satisfactory return to step 26a), otherwise
c) all permutations of sequences of matrix characters that may be selected by the user are compared with a stored history of successful user verifications, then
d) if a recently used sequence of matrix characters is matched with a possible sequence of matrix characters from the current session, return to step 26a), otherwise
e) populate the remainder of the matrix using an algorithm to maximize the number of matrix cells containing matrix characters that may be found in possible user-selected sequences of matrix characters.

27. A method according to claim 16 in which the matrix supplied to both the user and the computer system is generated externally to the computer system.

28. A method according to claim 27 in which the externally generated matrix is submitted to the computer system for verification along with the sequence of matrix characters selected by the user according to the steps of:
a) checking to ensure that the matrix together with the user sequence have not been used previously or at least not for a prescribed number of user verifications, and
b) checking to ensure that where the user sequence has been used previously, the current matrix differs sufficiently from the matrix associated with the previous usage, and
c) checking to ensure adequate diversity of matrix characters in the matrix, and
d) if the submitted matrix and user sequence combination is considered unsatisfactory the computer system must reject the user verification session.

29. A method according to claim 16 in which the computer system may be a computer controlled device such as an electronic lock.

30. A method of verifying the identity of a user of a multi-user computer system which includes the steps of:
a) providing the user with a unique user named account within the computer system;
b) providing the user named account with one or more secret ID codes comprising a number of user characters;
c) providing the user named account with one or more usage rules governing how the secret ID codes may be used to locate matrix characters within a matrix to be supplied and how the located matrix characters may be modified;
d) initiating an identity verification session by entering into the user interface of the computer system the unique user name;
e) generating the matrix for an identity verification session comprising an array of cells in which each cell contains one or more matrix characters and in which each cell may be referenced by column and/or row labels in which the user characters may be found together with other superfluous characters;
f) the matrix being created in a single process from a single source and the matrix being made available to the user and the computer system;
g) entering into the user interface of the computer system a user sequence of characters based on matrix characters selected by the user employing one of the secret ID codes and the usage rules;
h) generating within the computer system one or more comparison sequences of matrix characters derived from the application of each of the user's secret ID codes using the matrix and the usage rules; and
i) checking the user sequence against one or more comparison sequences and verifying the identity of the user upon finding a match.
